(19) United States
(12) Patent Application Publication
(10) Pub. No.: US 2005/0288455 A1
(43) Pub. Date: Dec. 29, 2005

(54) Curable epoxy resin composition

(75) Inventors: Makoto Ashiura, Hiratsuka-shi (JP); Tomoyuki Matsumura, Hiratsuka-shi (JP); Tetsuji Kawazura, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: THE YOKOHAMA RUBBER CO., LTD.

(21) Appl. No.: 11/154,539

(22) Filed: Jun. 17, 2005

(30) Foreign Application Priority Data
Jun. 29, 2004 (JP) 2004-191518

(51) Int. Cl. C08L 63/00; C08L 53/00; B32B 27/38

(52) U.S. Cl. 525/523; 525/88

(57) ABSTRACT

A curable epoxy resin composition containing a modified polymer (A) modified with a TEMPO derivative having a nitroxide radical with an epoxy reactive group in the molecule thereof, an epoxy resin (B) and an epoxy curing agent (C).

### TECHNICAL FIELD

The present invention relates to a curable epoxy resin composition. More specifically, it relates to a curable epoxy resin composition giving a cured article having improved flexibility and toughness.

### BACKGROUND ART

A cured article of a typical epoxy resin is relatively insufficient in flexibility and toughness and has problems in impact resistance and strength at break. To eliminate these problems, a large number of methods for blending rubber into the epoxy resin have been proposed. For example, Japanese Unexamined Patent Publication (Kokai) No. 4-180956 discloses a modified epoxy resin having little stress concentration at the boundary of a rubber layer, to which a carboxyl-terminal liquid acrylonitrile butadiene rubber is added, and an epoxy resin layer. Further, U.S. Pat. No. 4,812,521 discloses an epoxy resin modified with an acrylamide-diene-acrylonitrile rubber.

### DISCLOSURE OF INVENTION

Accordingly, the object of the present invention is to further improve the flexibility and toughness of an epoxy resin, while maintaining the heat resistance of the cured article of the epoxy resin.

In accordance with the present invention, there is provided a curable epoxy resin composition comprising a modified polymer (A) modified with a TEMPO derivative having a nitroxide radical having an epoxy reactive group in the molecule thereof, an epoxy resin (B) and an epoxy curing agent (C).

According to the present invention, it is possible to uniformly and finely disperse particles of a modified polymer (A) (i.e. rubber) modified with a TEMPO (that is, 2,2,6,6-tetramethyl-1-piperidinyloxy radical) derivative disclosed in, for example, Japanese Unexamined Patent Publication (Kokai) No. 10-182881, in a small particle size, in a matrix layer of an epoxy resin, and, as a result, it is possible to improve the toughness of an epoxy resin, while maintaining the heat resistance (Tg) of the epoxy resin.

### BRIEF DESCRIPTION OF DRAWINGS

FIG. 1 is a scan-type electron micrograph (X500) in place of a drawing showing the state of dispersion of the curable composition of Example 1;

FIG. 2 is an enlarged electron micrograph (X1000) of an epoxy resin layer part of FIG. 1;

FIG. 3 is a scan-type electron micrograph (X500) in place of a drawing showing the state of dispersion of the curable composition of Comparative Example 1; and

FIG. 4 is an enlarged electron micrograph (X1000) of an epoxy resin layer part of FIG. 3.

### BEST MODE FOR CARRYING OUT THE INVENTION

Cured articles of epoxy resins are superior, with the comparison thermoplastic resins in the dimensional stability and heat resistance and have high mechanical strength, but have the defect of being brittle. As one method for improving the brittleness of epoxy resins, it is widely used to blend a rubber into the epoxy resin. The present inventors thought that, to improve the toughness of an epoxy resin by blending rubber thereinto, it is necessary to obtain an island-in-the-sea structure composed of the rubber uniformly dispersed in the matrix layer of the epoxy resin in a separation phase manner and it is desirable that the particle size of the rubber is made finer to a suitable size. Therefore, the inventors found that, by blending a modified polymer (rubber) modified with a TEMPO derivative having an epoxy reactive group into an epoxy resin, the particle size of the dispersed rubber in the epoxy resin layer is made suitably finer and the toughness is improved, while maintaining the glass transition temperature of the cured article.

As schematically shown in the following chemical formulae, it is possible to obtain a modified polymer by modifying the same by adding a stable free radical TEMPO derivative, which is superior in carbon radical trapping capability, and a radical initiator in a specified ratio.

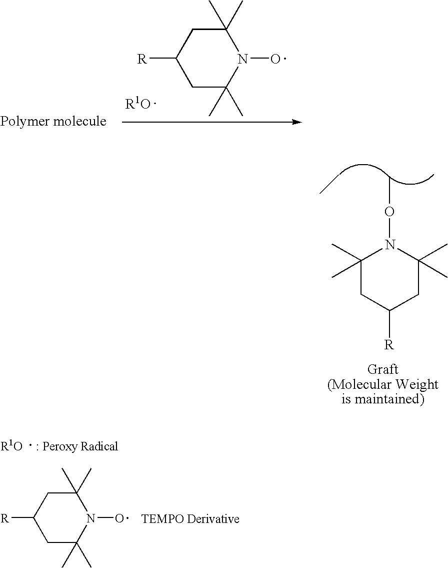

TEMPO derivatives having a stable free radical quickly trap radicals produced by the cleavage of rubber by light, heat or mechanical action. However, if trying to introduce functional groups into the molecules of a polymer, it is not possible to sufficiently modify the polymer only with a stable free radical such as a compound having TEMPO. Therefore, it is possible to add a radical initiator to positively cause the generation of carbon radicals on the polymer molecular chain so as to introduce the desired functional groups into the polymer molecules as shown in the above chemical formulae.

The polymers capable of being modified according to the above technique include, for example, a hydrogenated acrylonitrile-butadiene copolymer rubber (H-NBR), a butyl rubber (IIR), a halogenated butyl rubber, an isobutylene-p-methylstyrene copolymer, a brominated isobutylene-p-methylstyrene copolymer, polyisobutylene, polybutene, an ethylene-propylene-diene terpolymer (EPDM), an ethylene-propylene copolymer (EPM), an ethylene-butene copolymer, a polystyrene-based TPE (SEBS, SEPS), a polyolefin-based TPE, a fluororubber, natural rubber (NR), polyisoprene rubber (IR), various styrene-butadiene copolymers (SBR), various polybutadienes (BR), acrylonitrile-butadiene copolymer rubber (NBR), styrene-isoprene-butadiene copolymer, chloroprene rubber (CR), acryl rubber, silicone rubber, epichlorohydrin rubber, various polymethacrylic acid esters, various polyethylenes, various polyethers, various polysulfides, various polyvinylethers, various polyesters, various polyamides, cellulose, starch, various polyurethanes, various polyureas, various polyamines, etc.

As the TEMPO derivatives including a nitroxide radical (—N—O.) having an epoxy reactive group in the molecule thereof usable in the present invention, the following compounds may be mentioned. Note that the amounts of these compounds added are preferably 0.1 to 25 parts by weight, more preferably 0.5 to 20 parts by weight, based upon 100 parts by weight of the polymer Note that here, the “epoxy reactive group” means a functional group capable of reacting with an epoxy group. Specifically, for example, an amino group, carboxyl group, thiol group, isocyanate group, hydroxy group, epoxy group, thiirane group, oxetane group, acid anhydride group, aldehyde group, imino group, isothiocyanate group, thiocyan group, oxazoline group, oxazolidine group, alkoxysilyl group, etc. may be mentioned.

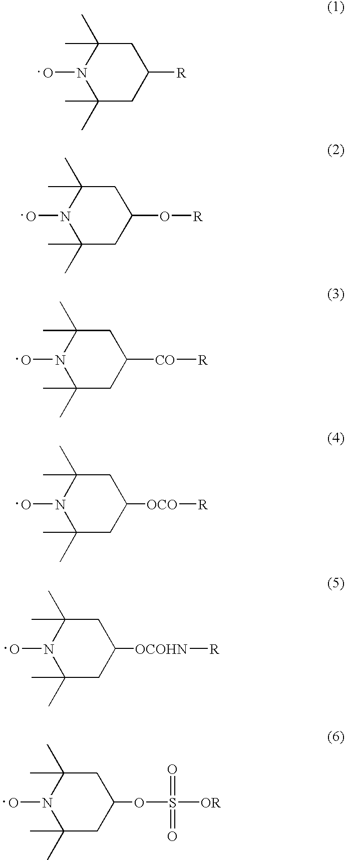

In the above formulae (1) to (6), R indicates an allyl group, amino group, isocyanate group, isothiocyanate group, hydroxy group, thiol group, vinyl group, epoxy group, thiirane group, carboxyl group, aldehyde group, carbonyl group-containing group (for example, cyclic acid anhydrides such as succinic anhydride, maleic anhydride, glutanic anhydride, phthalic anhydride) functional group-containing organic groups such as an oxetane group, imino group, oxazoline group, oxazolidine group, thiocyan group, silyl group, alkoxysilyl group.

Other examples are as follows.

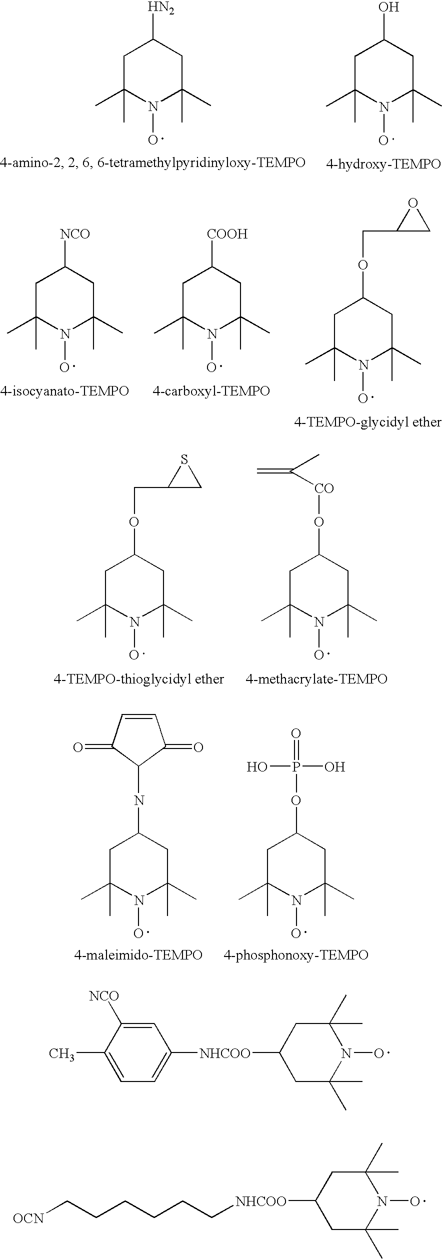

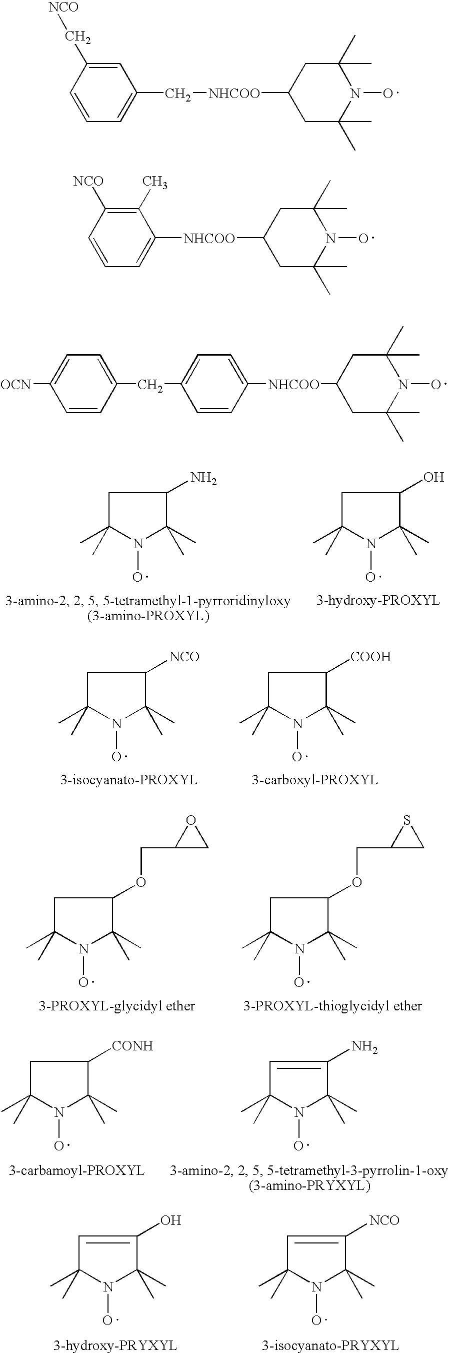

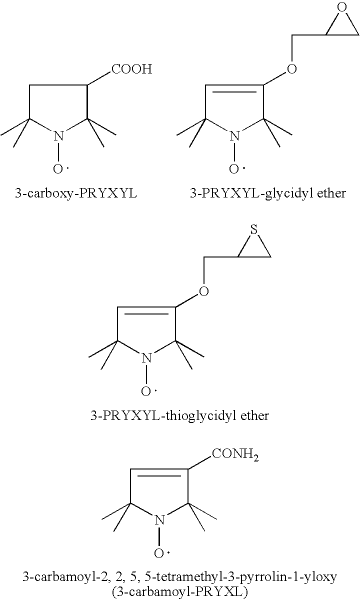

As the means for generating carbon radicals in the polymer, a radical initiator is added to the reaction system. The radical initiator includes, for example, organic peroxides such as benzoyl peroxide (BPO), t-butylperoxybenzoate (Z), dicumyl peroxide (DCP), t-butylcumyl peroxide (C), di-t-butyl peroxide (D), 2,5-dimethyl-2,5-di-t-butylperoxyhexane (2,5B), 2,5-dimethyl-2,5-di-t-butylperoxy-3-hexyne (Hexyne-3), 2,4-dichlorobenzoyl peroxide (DC-BPO), di-t-butylperoxy-di-isopropylbenzene (P), 1,1-bis(t-butylperoxy)-3,3,5-trimethyl-cyclohexane (3M), n-butyl-4,4-bis(t-butylperoxy)valerate, 2,2-bis(t-butylperoxy)butane, and radical generators such as azodicarbonamide (ADCA), azobisisobutylonitrile (AIBN), 2,2′-azobis-(2-amidinopropane)dihydrochloride, dimethyl-2,2′-azobis(isobutyrate), azobis-cyanvaleric acid (ACVA), 1,1′-azobis-(cyclohexane-1-carbonitrile) (ACHN), 2,2′-azobis-(2,4-dimethylvaleronitrile) (ADVN), azobismethyl butylonitrile (AMBN), 2,2′-azobis-(4-methoxy-2,4-dimethylvaleronitrile). These can generate carbon radicals in a polymer with the addition to a reaction system of the polymer and a compound having such nitroxide radicals (or mixture system or catalyzation system). The amount of the radical initiator added is preferably 0.1 to 15 parts by weight, more preferably 0.2 to 10 parts by weight, based upon 100 parts by weight of the polymer.

The ratio of the addition amounts of the TEMPO derivative having a nitroxide radical in the molecule thereof and the radical initiator is preferably a molar ratio of a compound having a nitroxide in the molecule thereof/radical initiator of at least 1.5, more preferably 1.7 to 5.0. If this ratio is less than 1.5, it is not preferable that the breakage of the polymer chains during modification will not be able to be suppressed as a result, the molecular weight may be decreased and a cross-linking reaction may occur to cause gelling.

The curable epoxy resin composition according to the present invention contains a modified polymer (A) modified with the TEMPO derivative, an epoxy resin (B) and epoxy curing agent (C). The blending ratios of these components are not particularly limited, but a blending amount of the modified polymer (A) is preferably 0.1 to 80 parts by weight, more preferably 1 to 20 parts by weight based on 100 parts by weight of the epoxy resin (B). If the ratio of the modified polymer (A) to the epoxy resin (B) is too small, the cured article may not be able to provide sufficient toughness, while conversely if too large, the shapeability when not yet cured is liable to deteriorate and the rigidity and heat resistance of the cured article are liable to be decreased. The amount of the epoxy curing agent (C) added is preferably 0.1 to 1.3 equivalents to the epoxy group in the composition.

The epoxy resin (B) used in the present invention is not particularly limited, but, for example, bisphenol group-containing epoxy compounds such as biphenol A type, bisphenol F type, hydrated bisphenol A type, bisphenol AF type, brominated bisphenol A type, bisphenol S type, biphenyl type, polyalkylene glycol based and alkylene glycol based epoxy compounds and further bifunctional glycidyl ether epoxy resins such as epoxy compounds having naphthalene rings, epoxy compounds having fluorene rings, multifunctional glycidyl ether type epoxy resins such as phenol novolak based, o-cresol novolak based, DPP novolak based, tris-hydroxyphenylmethane based, trifunctional based, tetraphenylolethane based, synthetic fatty acid glycidyl ester based epoxy resins such as dimeric acid aromatic epoxy resins having glycidylamino groups such as N,N,N′,N′-tetraglycidyl diaminodiphenylmethane (TGDDM), tetraglycidyl-m-xylene diamine, triglycidyl-p-aminophenol, N,N′-diglycidyl aniline, alicyclic based epoxy resins; epoxy resins having sulfur atoms in the epoxy resin main chains such as FLEP10 made by Toray Thiokol; urethane-modified epoxy resins having urethane bonds; polybutadiene, liquid polyacrylonitrile-butadiene rubber, rubber-modified liquid epoxy resin containing NBR, etc. may be used. These may be used alone or in any combinations of two or more types.

The kind of the epoxy curing agent (C) used in the present invention is not particularly limited. It is possible to mention any curing agent generally used in the past for curing an epoxy resin. Specific examples are general curing agents such as ethylenediamine, diethylenetriamine, triethylenetetramine, tetraethylenepentamine, dipropylenediamine, diethylaminopropylamine, hexamethylenediamine, menthenediamine, isophoronediamine, bis(4-amino-3-methyldicyclohexyl)methane, diaminodicyclohexylmethane, bis(amino-methyl)cyclohexene, tetramethyldiaminodiphenyl-methane, N-aminomethylpiperazine, 3,9-bis(3-aminopropyl)2,4,8,10-tetraoxaspiro(5,5)undecane, m-xylenediamine, m-phenylenediamine, diamino-diphenylmethane, diaminodiphenylsulfone, diaminodiethyldiphenylmethane, benzyldimethylamine, 2-(dimethylaminomethyl)phenol, 2,4,6-tris(dimethylaminomethyl)phenol, linear diamine, linear tertiary amine, tetramethylguanidine, triethanolamine, N,N′-dimethylpiperazine, triethylenediamine, DBU, pyridine, picoline, piperazine, pyrrolidine, and other amino-based curing agents, dodecenyl succinic anhydride, polyadipic anhydride, polyazelaic anhydride, polysebacic anhydride, poly(ethyloctadecane diacid) anhydride, poly(phenylhexadecane diacid) anhydride, methyltetrahydrophthalic anhydride, methylhexahydrophthalic anhydride, methyl himic anhydride, hexahydrophthalic anhydride, tetrahydrophthalic anhydride, trialkyl tetrahydrophthalic anhydride, methylcyclohexene dicarboxylic anhydride, phthalic anhydride, trimellitic anhydride, pyromellitic anhydride, benzophenone tetracarboxylic anhydride, ethylene glycol bistrimellitate, glycerol tristrimellitate, HET anhydride, tetrabromophthalic anhydride, and other acids and acid anhydride-based curing agents or polyamides, 2-ethyl-4-methylimidazole, and other imidazoles, ureas, dicyandiamide, and other amide amine-based curing agents, phenols or their derivatives, isocyanate, mercapto-based curing agents, Lewis acid salts, Bronsted acid salts, aminosilane condensates.

The curable epoxy resin composition according to the present invention may further contain, in addition to the above essential components, if necessary, a plasticizer, filler, catalyst, solvent, UV absorbent, dye, pigment, flame retardant, reinforcing agent, antioxidant, thixotropic agent, surfactant (including leveling agents), dispersant, dehydrating agent, rustproofing agent, tackifier, anti-static agent, or other various additives generally blended into epoxy resin compositions. The compounding amounts of these additives can be general amounts unless the objects of the present are not adversely affected.

### EXAMPLES

The present invention will now be further illustrated by, but is by no means limited to, the following Examples.

### Example 1 and Comparative Examples 1 and 2

### Synthesis of Epoxy-Modified Hydrogenated NBR

350 g of Hydrogenated NBR (Zetpol 2000L made by Nippon Zeon) 24.1 g of di-t-butylperoxide and 45 g of 4-glycidyl-2,2,6,6-tetramethylpiperidinyl-1-oxyl were placed in a closed type Bambury mixer set to 60° C. in temperature and mixed for 15 minutes. The mixture thus obtained was mixed in a closed type Bambury mixer set to 100° C. in temperature with nitrogen substitution for 5 minutes. While mixing, the temperature was raised to 186° C. and then the mixture was mixed for a further 15 minutes. A part of the polymer thus obtained was dissolved in toluene and a reprecipitation operation used to isolate and purify the polymer. The purified product was analyzed by ¹H-NMR, whereupon the introduction of an epoxy group was confirmed.

Curing of Epoxy Resin

Each component shown in Table I was uniformly dissolved in methyl ethyl ketone of five times the amount of rubber (H-NBR, epoxy-modified H-NBR or X-NBR), the solvent was removed, and then the temperature was raised from 80° C. by 2° C./min, while starting the curing. The mixture was heated up to 180° C. and cured at 180° C. for 2 minutes.

TABLE I

| Formulation (parts by | | Comp. | Comp. |
|---|---|---|---|
| weight) | Ex. 1 | Ex. 1 | Ex. 2 |
| H-NBR *1 | — | 5 | — |
| Epoxy-modified H-NBR *2 | 5 | — | — |
| X-NBR *3 | — | — | 5 |
| DGEBA *4 | 100 | 100 | 100 |
| Tetramethyl DDM *5 | 33.5 | 33.5 | 33.5 |

*1 Hydrogenated acrylonitrile butadiene rubber made by Nippon Zeon (Zetpol 2000L)
*2 Zetpol 2000L modified product (see above Synthesis Example)
*3 X-NBR Nipol 1072J made by Nippon Zeon (carboxy modified)
*4 Diglycidylether bisphenol A made by Asahi Denka (EP4100E)
*5 Tetramethyl diaminodiphenylmethane made by Nippon Kayaku (Gayabond C-200S)

Next, the physical properties of the curable composition thus obtained were determined as follows. The results are shown in Table II.

TABLE II

| | | Comp. | Comp. |
|---|---|---|---|
| | Ex. | Ex. 1 | Ex. 2 |
| Fracture toughness value Kc | 120 | 101 | 112 |
| (index) *1 | | | |
| Dispersability of rubber | Uniform | Separated | Uniform |
| Visual *2 | | | |
| Particle size at resin | Small | Large | Small |
| layer *3 | | | |
| Molecular weight of rubber | 220000 | 215000 | 230000 |
| (Mn) *4 | | | |
| Glass transition temperature | 200.3 | 200.1 | 202.9 |
| (° C.) *5 | | | |

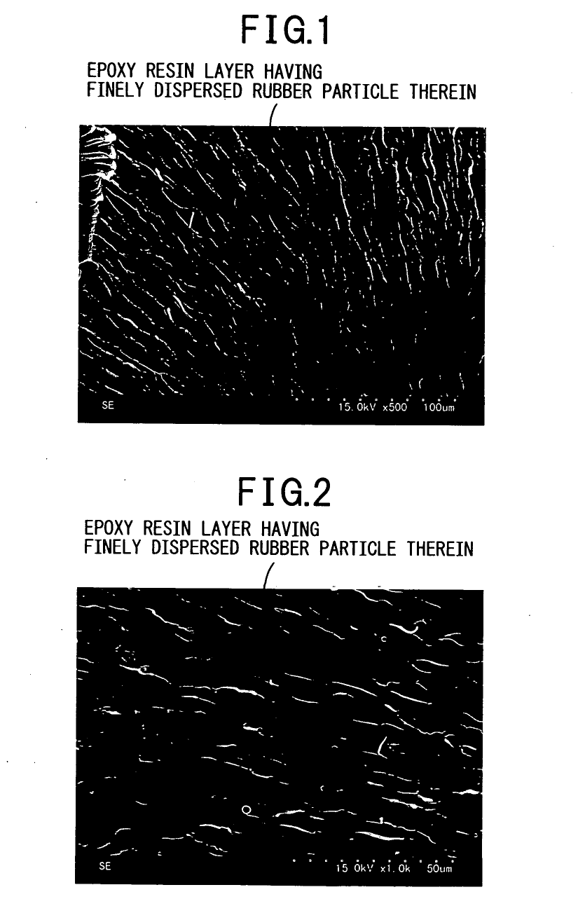

*1 Toughness: An AGS-J 1KN made by Shimazu Corporation was used to measure the fracture toughness value Kc according to ASTM D5054-99 method. The results were shown as an index. The larger the value, the tougher.
*2 Dispersability of rubber: A scan type electron microscope was used for examination to evaluate the dispersability and particle size of the rubber particles in the epoxy resin. Electron micrographs of Example 1 and Comparative Example 1 are shown in FIGS. 1 to 2 and FIGS. 3 to 4.
*3 Number average molecular weight (Mn) of rubber: Measured by GPC under the conditions, i.e., measured at 40° C. using THF as elute. The molecular weight was calibrated by standard polystyrene.
*4 Glass transition temperature of composition: Measured by TMA under the conditions (i.e., compression mode with temperature increase rate of 10° C./min (load 30 mN)).

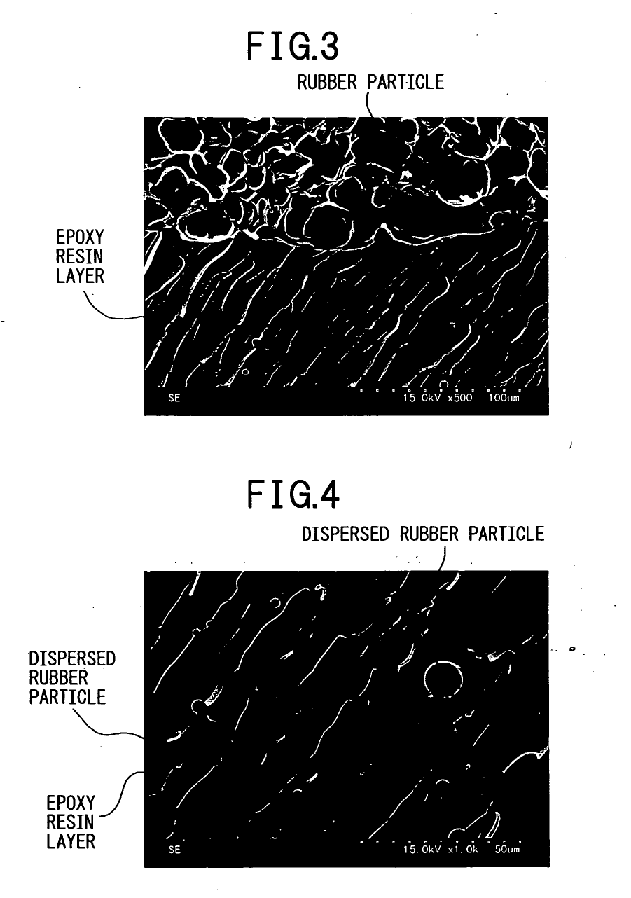

As shown in Table II and FIGS. 1 to 4, the cured article of Example 1 according to the present invention has a good rubber dispersability (uniform dispersion of small particle size rubber particles in epoxy resin layer) and superior toughness. As opposed to this, in Comparative Example 1, as shown in FIG. 3, the epoxy resin layer and the rubber particles are separated. Further, as seen in FIG. 4 of an enlarged view of the epoxy resin part, the size of the rubber particles included in the epoxy resin layer is also large and the toughness insufficient. In addition, Example 1 exhibits a higher toughness than Comparative Example 2 in which the carboxy-modified NBR (commercially available) is added.

### INDUSTRIAL APPLICABILITY

As explained above, the curable epoxy resin composition according to the present invention is superior in toughness and is useful for use as an epoxy resin laminate such as a prepreg, epoxy resin binder, coating, repair material, paving material, FRP, packaging material, etc.

1. A curable epoxy resin composition comprising a modified polymer (A) modified with a 2,2,6,6-tetramethyl-1-piperidinyloxy (TEMPO) derivative having a nitroxide radical with an epoxy reactive group in the molecule, thereof, an epoxy resin (B) and an epoxy curing agent (C).

2. A curable epoxy resin composition as claimed in claim 1, wherein the epoxy reactive group of the modified polymer (A) is an epoxy group.

3. A curable epoxy resin composition as claimed in claim 1, wherein the polymer capable of producing the modified polymer (A) is a hydrogenated acrylonitrile-butadiene copolymer rubber.

4. A curable epoxy resin composition as claimed in claim 1, wherein the amount of blending of said component (A) is 0.1 to 80 parts by weight based upon 100 parts by weight of the component (B).
